(19) United States
(12) Patent Application Publication
(10) Pub. No.: US 2025/0206376 A1
(43) Pub. Date: Jun. 26, 2025

(54) BATTERY FIXING STRUCTURE

(71) Applicant: SUBARU CORPORATION, Tokyo (JP)

(72) Inventor: Shungo YAMAMOTO, Tokyo (JP)

(73) Assignee: SUBARU CORPORATION, Tokyo (JP)

(21) Appl. No.: 18/974,899

(22) Filed: Dec. 10, 2024

(30) Foreign Application Priority Data
Dec. 26, 2023 (JP) 2023-218955

(51) Int. Cl. B62D 21/15; B60R 16/04; H01M 50/242; H01M 50/249; H01M 50/264

(52) U.S. Cl. CPC B62D 21/152; B60R 16/04; H01M 50/242; H01M 50/249; H01M 50/264; H01M 2220/20

(57) ABSTRACT

A battery fixing structure includes a battery mounting member configured to support a battery in an engine room of a vehicle, a bracket configured to join a vehicle body panel of the vehicle to a vehicle body frame of the vehicle on an outer side of the battery mounting member in a vehicle width direction of the vehicle, and a first restricting member provided integrally to the bracket and disposed at a first position which is opposite to an outer surface of the battery in the vehicle width direction, the battery being configured to move to the first position in a case where the battery is displaced toward an outer side of the vehicle width direction when the vehicle collides. The first restricting member is joined to the battery mounting member.

### CROSS-REFERENCE TO RELATED APPLICATION

The present application claims priority from Japanese Patent Application No. 2023-218955 filed on Dec. 26, 2023, the entire contents of which are hereby incorporated by reference.

### BACKGROUND

The disclosure relates to a battery fixing structure configured to fix, to a vehicle body, a battery installed in the engine room of a vehicle such as an automobile.

In general, a battery is mounted as a power source for various electric components in the engine room of a vehicle such as an automobile. An example of batteries is a secondary battery, which is rechargeable, such as a lead storage battery, a lithium-ion battery, and the like

Such batteries tend to increase in size and weight as their charging capacity increases.

Therefore, various techniques have conventionally been proposed as a battery fixing structure to cope with a large battery.

For example, Japanese Unexamined Patent Application Publication (JP-A) No. 2002-225750 discloses a structure in which a battery bracket to mount a large battery is provided on an upper part of a front side frame, and a fragile part is formed at a corner of the battery bracket. This enables the battery bracket structure of JP-A No. 2002-225750 to increase collision absorption efficiency in the event of a frontal collision while being able to mount a large battery thereon.

Incidentally, a battery is usually fixed to a vehicle body by respectively attaching rods to both ends of a stay provided on the upper surface of the battery and hooking the lower ends of the rods to holes provided in the vehicle body frame and the like Furthermore, various measures are taken to prevent a battery from jumping out to for example the vehicle-lengthwise front due to impact of a vehicle collision in the event of a frontal collision.

For example, in addition to the fixation using a stay and rods, the battery has, around itself, a restricting member and the like configured to prevent the battery from jumping out in the event of a collision of a vehicle.

Such a restricting member is usually designed together with the vehicle body frame in the development stage of the vehicle body frame. Therefore, the restricting member is assembled into the vehicle body frame in advance at the same time as the assembly of a vehicle body frame member.

### SUMMARY

An aspect of the disclosure provides a battery fixing structure including: a battery mounting member configured to support a battery in an engine room of a vehicle; a bracket configured to join a vehicle body panel of the vehicle to a vehicle body frame of the vehicle on an outer side of the battery mounting member in a vehicle width direction of the vehicle; and a first restricting member provided integrally to the bracket and disposed at a first position which is opposite to an outer surface of the battery in the vehicle width direction, the battery being configured to move to the first position in a case where the battery is displaced toward an outer side of the vehicle width direction when the vehicle collides. The first restricting member is joined to the battery mounting member.

### BRIEF DESCRIPTION OF THE DRAWINGS

FIG. 1 is a perspective view illustrating a state in which a battery is fixed in an engine room;

FIG. 2 is an exploded perspective view illustrating a fixing structure configured to fix the battery in the engine room;

FIG. 3 is an enlarged perspective view illustrating a battery mounting member;

FIG. 4 is an enlarged perspective view illustrating a state in which the battery fixed in the engine room is removed;

FIG. 5 is an enlarged perspective view illustrating a state in which the battery is fixed in the engine room;

FIG. 6 is an enlarged perspective view illustrating a state in which a large battery is fixed in the engine room;

FIG. 7 is an enlarged perspective view illustrating a state in which the large battery fixed in the engine room is removed; and

FIG. 8 is a perspective view illustrating a behavior of the battery when a right front part of a vehicle is involved in a small-overlap frontal collision.

### DETAILED DESCRIPTION

There is a possibility that large batteries, depending on their size, cannot be mounted on a vehicle body frame having a restricting member assembled therein in advance. On the other hand, enlarging the vehicle body frame toward the vehicle-widthwise outer sides may involve a large-scale design change. Further, enlarging a vehicle body frame may prevent attaching of a front fender panel to the vehicle body frame.

The disclosure has been made in view of the above issues, and it is desirable to provide a battery fixing structure capable of adequately restricting a battery from jumping out in the event of a collision of a vehicle while suppressing a large-scale change to the vehicle body even when the size of the battery mounted on the vehicle body is changed.

Hereinafter, embodiments of the disclosure will be described with reference to the drawings.

The drawings referred to in the following description illustrate their components with different scales such that each of the components has a size that allows understanding in the drawings. Therefore, the disclosure is not limited only to the number of the components, the shape of the components, the ratio of the sizes of the components, and the relative positional relationship between the components described in these drawings.

As an example in which a battery fixing structure in the present embodiment is applied in an engine room, a description will be given as to a configuration of a left side part of a vehicle body of a front engine type vehicle. The term “join” used in the following description includes a joining method represented by fusion joining, structural joining, etc.

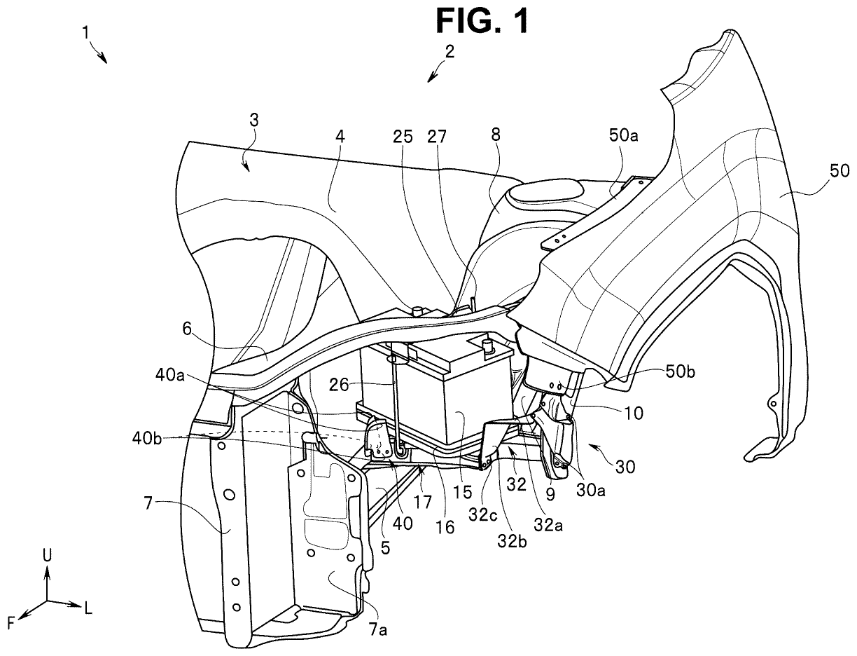

As illustrated in FIG. 1, a vehicle body 2 of a vehicle 1 includes an engine room 3 at a front part thereof.

The vehicle body 2 includes a toe board 4, a front side frame 5, an upper side frame 6, a radiator support side 7, a suspension tower 8, a wheel apron 9, and a front fender frame 10 as various vehicle body frames constituting the engine room 3. These vehicle body frames are formed by, for example, pressing a sheet metal member made of a high-strength steel plate etc.

The toe board 4 extends in the vehicle-widthwise direction as a partition wall that partitions the vehicle body into the cabin and the engine room 3.

The front side frame 5 projects toward the front side of the vehicle body 2 from the lower part of the toe board 4 on the vehicle-widthwise outer side of the toe board 4.

The upper side frame 6 is disposed on the vehicle-widthwise outer side of the engine room 3. The upper side frame 6 projects toward the vehicle-lengthwise front along the engine room 3 from the vehicle-widthwise outer side of a cowl top (not illustrated).

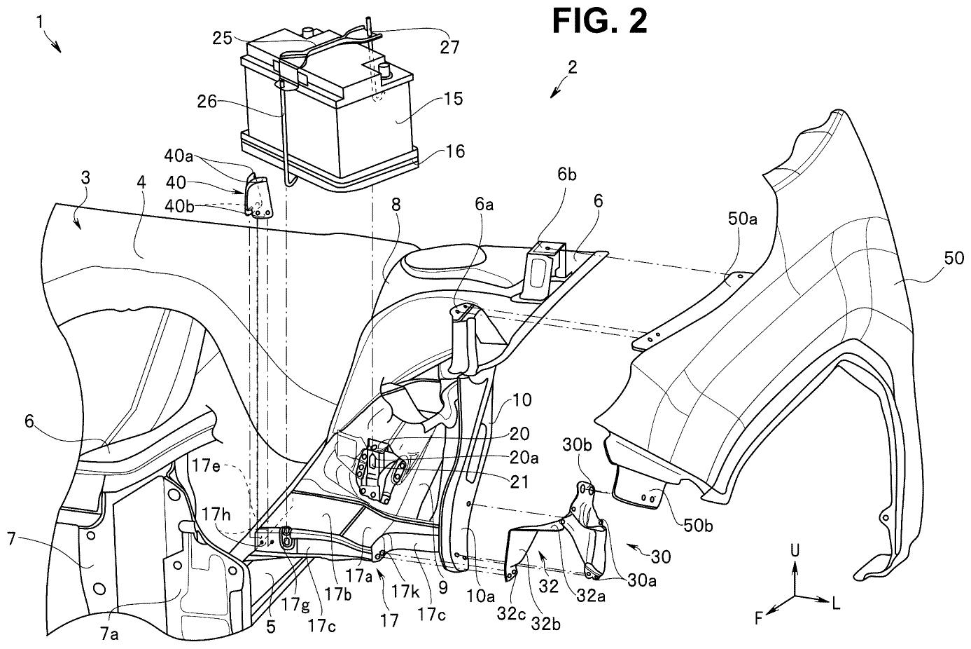

As illustrated in FIG. 2, the upper side frame 6 has a front bracket 6a and a rear bracket 6b each provided on the upper surface thereof and formed to protrude upward.

The radiator support side 7 supports the vehicle-widthwise outer side of a radiator panel (not illustrated) at the front part of the vehicle body. Further, the upper end of the radiator support side 7 is joined to the lower surface of the distal end of the upper side frame 6.

Further, the radiator support side 7 has a joining flange 7a.

The joining flange 7a projects toward the vehicle-widthwise outer side from the side surface of the radiator support side 7. The distal end of the front side frame 5 is joined to the back surface of the joining flange 7a projecting in this manner.

The suspension tower 8 is provided between the front side frame 5 and the upper side frame 6. The suspension tower 8 supports an upper part of a suspension device (not illustrated).

As illustrated in FIG. 2, the wheel apron 9 is provided at a front part of the suspension tower 8. The wheel apron 9 projects upward and toward the vehicle-widthwise outer side in a state of being joined to the upper surface of the front side frame 5.

As illustrated in FIG. 2, for example, the front fender frame 10 is provided on the vehicle-widthwise outer side of the wheel apron 9. The upper end part of the front fender frame 10 is joined to the lower surface of the upper side frame 6. The rear end part of the front fender frame 10 is joined to the vehicle-widthwise outer end part of the wheel apron 9.

Further, the front fender frame 10 has a bracket mounting surface 10a.

The bracket mounting surface 10a is provided on the vehicle-widthwise outer surface of the front fender frame 10.

The bracket 30 can be mounted on the bracket mounting surface 10a. That is, the bracket 30 can be mounted on the bracket mounting surface 10a in a process after a process of assembling the vehicle body frame.

The bracket 30 fixes a front fender panel 50 serving as a vehicle body panel to the vehicle body frame together with the front bracket 6a and the rear bracket 6b.

Thus, the bracket 30 includes, for example, a pair of bracket joining flanges 30a and a fender panel mounting flange 30b.

The pair of bracket joining flanges 30a is provided at a position opposite to the vehicle-widthwise outer side of the bracket mounting surface 10a. Each of the bracket joining flanges 30a is formed at a predetermined interval in the vehicle-heightwise direction of the bracket mounting surface 10a.

Each of such bracket joining flanges 30a can abut on the bracket mounting surface 10a.

The fender panel mounting flange 30b is formed at the upper part of the bracket 30. The fender panel mounting flange 30b functions as a flange configured to mount the front part of the front fender panel 50 thereon.

The bracket 30 configured as described above can be joined to the bracket mounting surface 10a in a state in which each of the bracket joining flanges 30a is abutting on the bracket mounting surface 10a. The bracket 30 is formed by, for example, pressing a sheet metal member made of a high-strength steel plate etc.

As illustrated in FIG. 2, the front fender panel 50 includes an upper flange 50a and a front flange 50b.

The upper flange 50a projects toward the vehicle-widthwise inner side from a vehicle-heightwise upper edge of the front fender panel 50. The upper flange 50a serves as a joint part configured to mount the upper part of the front fender panel 50 on the upper side frame 6. Therefore, the upper flange 50a can abut on each of the upper surfaces of the front bracket 6a and the rear bracket 6b from above.

The front flange 50b projects toward the vehicle-lengthwise front from a vehicle-lengthwise front edge of the front fender panel 50. The front flange 50b is provided at a position opposite to the vehicle-widthwise outer side of the fender panel mounting flange 30b. Therefore, the front flange 50b can abut on the fender panel mounting flange 30b when the front part of the front fender panel 50 is mounted on the bracket 30.

The front fender panel 50 configured as described above can be joined to the front bracket 6a, the rear bracket 6b, and the fender panel mounting flange 30b using a clip (not illustrated) in a state in which the upper flange 50a and the front flange 50b are abutting on each other.

A battery mounting member 17 configured to mount the battery 15 thereon is provided on a vehicle body left side part formed by such various vehicle body frames.

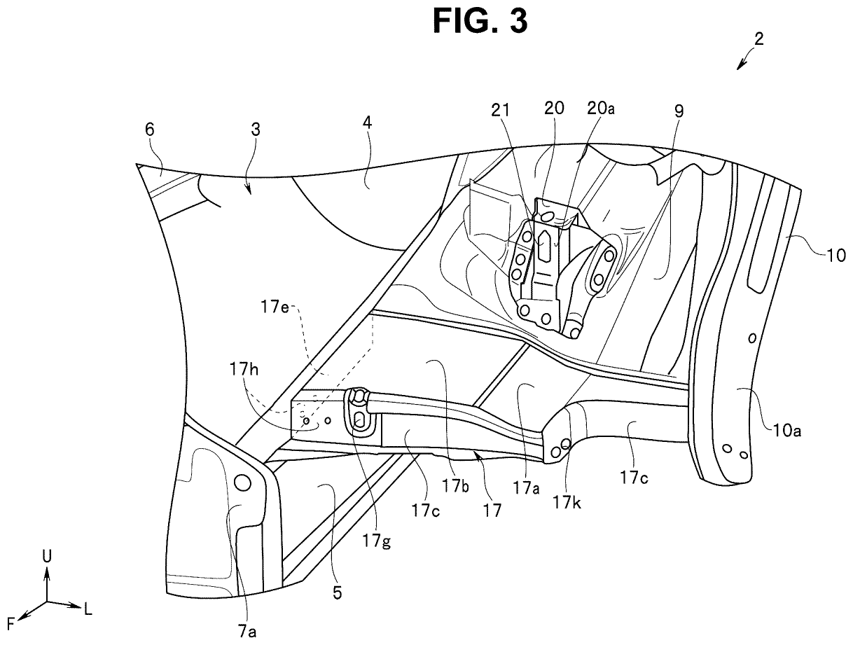

As illustrated in FIG. 2 and FIG. 3, the battery mounting member 17 is disposed, for example, at the front part of the wheel apron 9 and between the front side frame 5 and the front fender frame 10. Thus, the battery mounting member 17 is joined to the wheel apron 9, the front side frame 5, and the front fender frame 10. Such a battery mounting member 17 is formed by, for example, pressing a sheet metal member made of a high-strength steel plate etc.

Specifically, as illustrated in FIG. 3, the battery mounting member 17 includes a top plate 17a, a front wall 17c, and a side wall 17e.

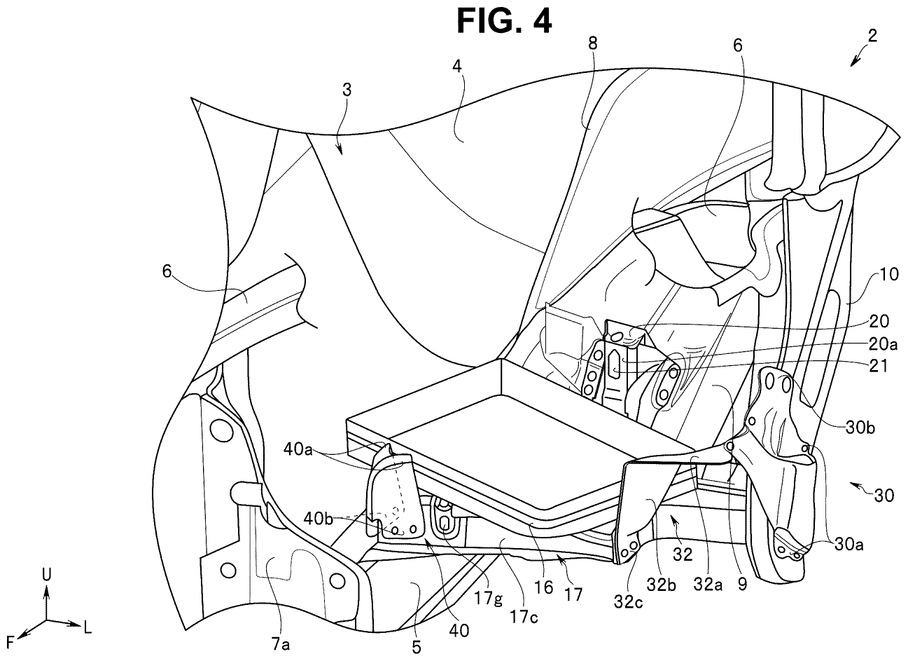

The top plate 17a extends in the vehicle-widthwise direction. The top plate 17a has a mounting surface 17b on which a battery tray 16 can be mounted in a region on the vehicle-widthwise inner side (refer to FIG. 3 and FIG. 4). The mounting surface 17b is formed of a substantially horizontal plane. The mounting surface 17b is disposed at a position higher than the upper surface of the front side frame 5.

Here, in the region on the vehicle-widthwise outer side, a part of the front side of the top plate 17a is cut out. Accordingly, the forward-and-rearward width of a part of the region on the vehicle-widthwise outer side of the top plate 17a is formed to be narrower than the forward-and-rearward width on the vehicle-widthwise inner side (the mounting surface 17b).

The front wall 17c projects downward from the front edge of the vehicle body of the top plate 17a. Therefore, a part of the front wall 17c is bent in a crank shape along the shape in which the top plate 17a is cut out.

The side wall 17e projects downward from the vehicle-widthwise inner edge of the mounting surface 17b. The lower edge of the side wall 17e is joined to the front side frame 5.

In the front wall 17c and the side wall 17e, the front wall 17c is provided with a front rod hole 17g and a side restricting member mounting surface 17k, as illustrated in FIG. 3. A pair of front restricting member mounting surfaces 17h is provided at a corner formed by the front wall 17c and the side wall 17e. Further, the wheel apron 9 is provided with a rear rod mounting member 20 at a position opposite to the front rod hole 17g via the battery mounting member 17.

The front rod hole 17g is provided substantially at the vehicle-widthwise middle of the mounting surface 17b. The front rod hole 17g has a long hole shape capable of hooking a hook.

The side restricting member mounting surface 17k is set to a surface substantially opposite to the front end of the front fender frame 10 among surfaces formed by the front wall 17c. Such an opposing surface is formed by bending the front wall 17c in a crank shape along the shape of the top plate 17a. The side restricting member mounting surface 17k and the pair of front restricting member mounting surfaces 17h are flat surfaces.

As illustrated in FIG. 2, FIG. 3, and FIG. 4, the rear rod mounting member 20 is provided at a position opposite to the rear surface of the battery 15. Therefore, the rear rod mounting member 20 has a rear rod mounting surface 20a formed to protrude upward substantially from the inclined surface of the wheel apron 9.

The rear rod mounting surface 20a is provided with a rear rod hole 21. The rear rod hole 21 has a long hole shape capable of hooking a hook.

The surfaces of the battery 15 and the battery tray 16 are defined as follows for convenience.

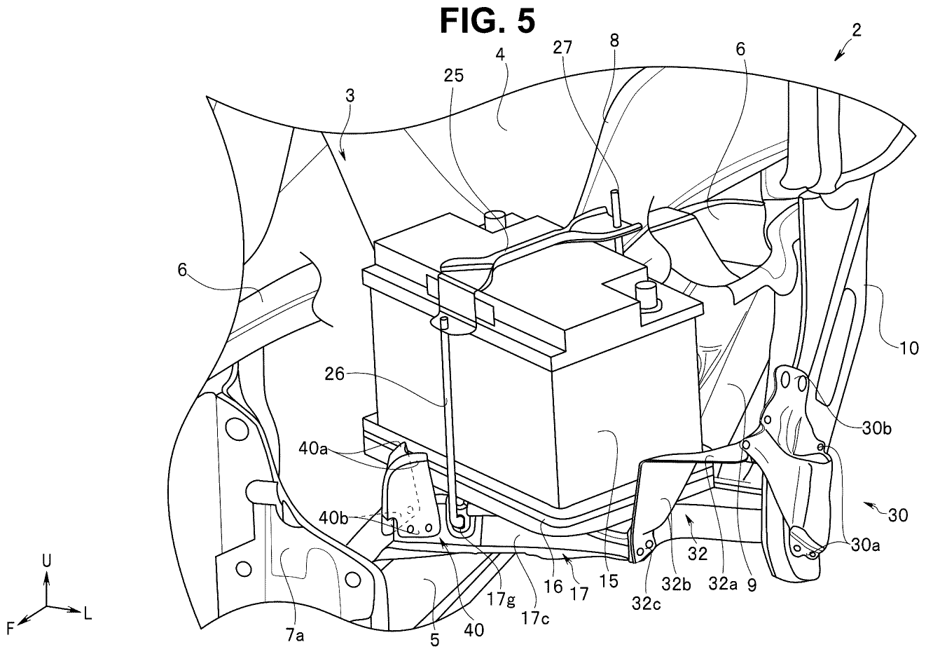

That is, as illustrated in FIG. 5, in a state in which the battery 15 and the battery tray 16 are mounted on the battery mounting member 17, a surface on the front side of the vehicle body is defined as a front surface, a surface opposite to the front surface is defined as a rear surface, and a surface in the vehicle-widthwise direction is defined as a side surface. Further, in this state, surfaces in the height direction are respectively defined as a top surface and a bottom surface.

A fixing member configured to fix the battery 15 to the battery mounting member 17 can be mounted on the battery mounting member 17 and the rear rod mounting member 20 configured as described above. Therefore, the fixing member is disposed around the battery 15.

For example, as illustrated in FIG. 2 and FIG. 5, on the front surface side of the battery 15 mounted on the mounting surface 17b via the battery tray 16, the lower end part of a front rod 26 is locked to the front rod hole 17g. Further, on the rear surface side of the battery 15, the lower end part of the rear rod 27 is locked to the rear rod hole 21. Further, the upper end parts of the front rod 26 and the rear rod 27 are fastened to a battery stay 25 disposed in the lateral direction of the upper surface of the battery 15 by a nut. As a result, the front rod 26, the rear rod 27, and the battery stay 25 constitute a fixing member configured to stably fix the battery 15 to the battery mounting member 17. As such various fixing members, those having a shape corresponding to the size and the like of the battery 15 are selectively used. Therefore, regardless of a change in size and the like of the battery 15, the various fixing members can stably fix the battery 15 to the battery mounting member 17.

Restricting members that restrict displacement of the battery 15 in the event of a collision of the vehicle 1 are disposed around the battery 15 fixed in this manner.

Specifically, as illustrated in FIG. 2, FIG. 4, and FIG. 5, a side restricting member 32 and a front restricting member 40 are provided as restricting members on the side restricting member mounting surface 17k of the battery mounting member 17 and the pair of front restricting member mounting surfaces 17h.

The side restricting member 32 is integrally provided on the vehicle-widthwise inner side of the bracket 30. The side restricting member 32 has a substantially L-shape formed to project toward the vehicle-widthwise inner side from the bracket 30 and to be bent downward. The side restricting member 32 is formed by, for example, pressing a sheet metal member made of a high-strength steel plate etc.

Such a side restricting member 32 restricts the displacement amount of the battery 15 moving toward the vehicle-widthwise outer side by inertial force in the event of a collision of the vehicle 1. Therefore, the side restricting member 32 is disposed at a position which is opposite to the vehicle-widthwise outer surface of the battery 15 and over which the battery 15 is displaced toward the vehicle-widthwise outer side in the event of a collision of the vehicle 1.

In detail, the side restricting member 32 includes a top plate 32a, a vertical wall 32b, and a joining flange 32c.

As illustrated in FIG. 5, the top plate 32a projects toward the vehicle-widthwise inner side from the front edge substantially at the vehicle-heightwise middle of the bracket 30. The top plate 32a projecting in this manner is formed substantially parallel to the mounting surface 17b of the battery mounting member 17. That is, the top plate 32a is disposed substantially perpendicular to the vehicle-widthwise outer surface of the battery 15.

The vertical wall 32b projects downward from the vehicle-widthwise inner edge of the top plate 32a. As illustrated in FIG. 5, the vertical wall 32b is disposed substantially at the vehicle-lengthwise middle at a position opposite to the vehicle-widthwise outer surface of the battery 15. The height of the vertical wall 32b is set to a height at which the upper end of the vertical wall 32b is positioned substantially at the vehicle-heightwise middle of the battery 15.

The joining flange 32c is formed at a lower part of the vertical wall 32b. The joining flange 32c is provided at a position opposite to the vehicle-widthwise outer side of the side restricting member mounting surface 17k. Therefore, the joining flange 32c can abut on the side restricting member mounting surface 17k from the vehicle-widthwise outer side.

The side restricting member 32 configured as described above can be joined to the front fender frame 10 and the battery mounting member 17 together with the bracket 30.

Specifically, the side restricting member 32 can be joined to the bracket mounting surface 10a and the side restricting member mounting surface 17k together with the bracket 30 in a state in which each of the bracket joining flanges 30a and the joining flange 32c are integrally abutting from the vehicle-widthwise outer side.

Therefore, the step of joining the bracket 30 and the side restricting member 32 is performed after the step in which the vehicle body frame is assembled, and the battery mounting member 17 is provided on the vehicle body frame.

The shape of the side restricting member 32 can be changed depending on the size of the battery 15.

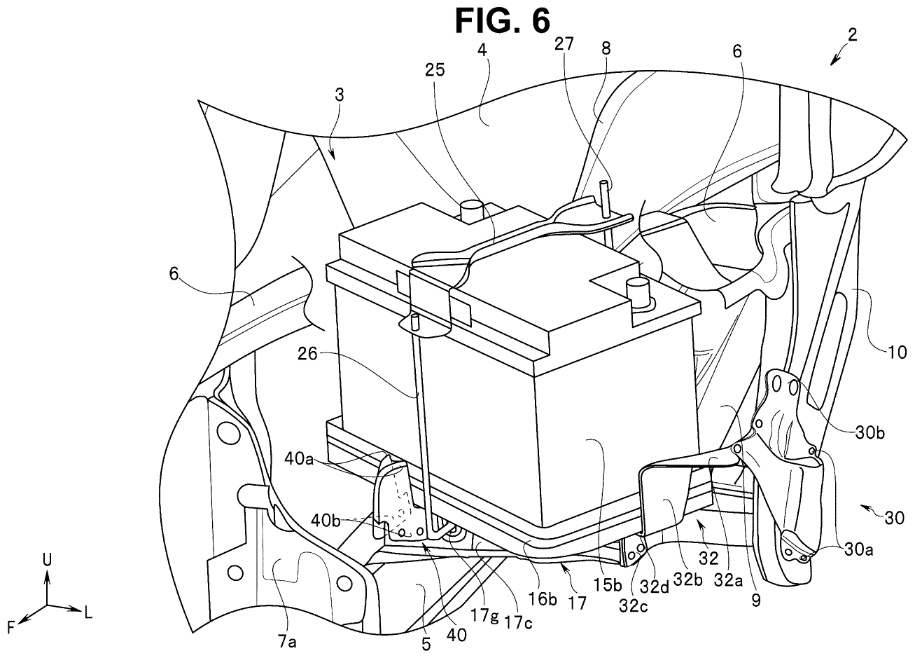

For example, as illustrated in FIG. 6, when a large battery 15b is mounted, the shape of side restricting member 32 is changed based on the shape, size, and the like of the large battery 15b.

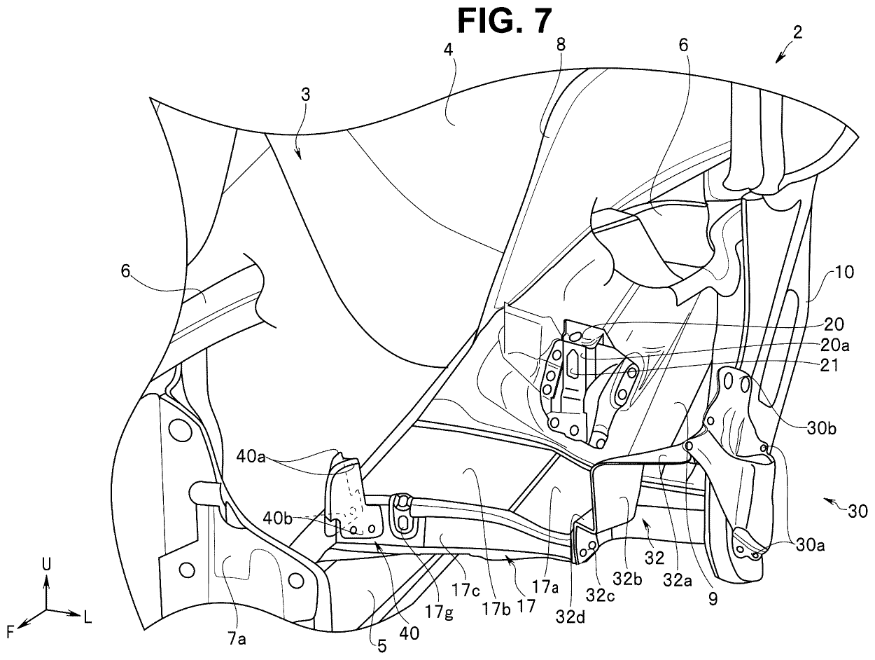

Specifically, the shape of the vertical wall 32b is bent stepwise together with the top plate 32a. That is, as illustrated in FIG. 7, a shelf 32d is additionally formed between the vertical wall 32b and the joining flange 32c.

The shelf 32d is formed at a position opposite to the bottom surface of a large battery tray 16b. The shelf 32d supports a part of the bottom surface on the vehicle-widthwise outer side of the large battery tray 16b. Therefore, the height of the shelf 32d in the vehicle-heightwise direction is substantially equal to the height of the mounting surface 17b. This makes it possible to restrict the movement of the large battery 15b to the vehicle-widthwise outer side even when the large battery 15b is mounted on the battery mounting member 17.

It is noted that various conditions such as the widths, plate thicknesses, and shapes of the top plate 32a, the vertical wall 32b, the joining flange 32c, and the shelf 32d are obtained in advance from experiments, simulations, and the like in order to adequately restrict the displacement amount of the battery 15 or the large battery 15b moving toward the vehicle-widthwise outer side in the event of a collision.

As described above, in the present embodiment, the side restricting member 32 corresponds to a specific example as a first restricting member.

The front restricting member 40 is disposed, for example, at a position opposite to the front surface of the battery 15 and over which the battery 15 is displaced toward the vehicle-lengthwise front in the event of a collision of the vehicle 1. Further, for example, the height of the front restricting member 40 is set substantially equal to the height of the battery tray 16. Therefore, the height of the front restricting member 40 is set to be lower than the height of the side restricting member 32.

Such a front restricting member 40 restricts the displacement amount of the battery 15 moving toward the vehicle-lengthwise front by inertial force in the event of a collision of the vehicle 1. Therefore, the front restricting member 40 is formed of, for example, a sheet metal member made of a high-strength steel plate etc.

In detail, the front restricting member 40 is formed of a pair of flat plates 40a.

The pair of flat plates 40a has a substantially V-shape in plan view that opens at a substantially right angle toward the front surface of the battery 15. As illustrated in FIG. 5, the pair of flat plates 40a is disposed at positions respectively opposite to the front restricting member mounting surfaces 17h. Therefore, the pair of flat plates 40a is disposed substantially at the vehicle-widthwise middle of the battery 15 at a position opposite to the front surface of the battery 15.

A pair of joint portions 40b to be joined to each of the front restricting member mounting surfaces 17h is continuously formed below the pair of flat plates 40a. The pair of joint portions 40b can be joined to the respective front restricting member mounting surfaces 17h in a state in which they are respectively abutting on the front restricting member mounting surfaces. That is, the front restricting member 40 can be joined to the corner of the battery mounting member 17.

Therefore, the step of joining the front restricting member 40 is performed after the step in which the vehicle body frame is assembled and the battery mounting member 17 is provided on the vehicle body frame.

The shape of the front restricting member 40 can be changed depending on the size of the battery 15.

For example, as illustrated in FIG. 6, when the large battery 15b is mounted, the shape of the front restricting member 40 is changed based on the shape, size, and the like of the large battery 15b.

Specifically, as illustrated in FIG. 7, a part of the edge of each flat plate 40a opposite to the front surface of the large battery tray 16b is cut out in an L-shape. This makes it possible to restrict forward movement of the large battery 15b even when the large battery 15b is mounted on the battery mounting member 17.

It is noted that various conditions such as a plate thickness and a shape of each flat plate 40a are obtained in advance from experiments, simulations, and the like in order to adequately restrict the displacement amount of the battery 15 or the large battery 15b moving toward the vehicle-lengthwise front in the event of a collision.

As described above, in the present embodiment, the front restricting member 40 corresponds to a specific example as a second restricting member.

The side restricting member 32 and the front restricting member 40 provided integrally with the bracket 30 are selectively used depending on the size of the battery 15. That is, the side restricting member 32 and the front restricting member 40 selected depending on the size of the battery 15 mounted on the battery tray 16 are mounted on the vehicle body frame etc.

According to such an embodiment, a battery fixing structure includes: a battery mounting member 17 capable of mounting a battery 15 thereon in an engine room 3; a bracket 30 configured to join a front fender panel 50 to a front fender frame 10 on a vehicle-widthwise outer side of the battery mounting member 17; and a side restricting member 32 provided integrally with the bracket 30 and disposed at a position which is opposite to a vehicle-widthwise outer surface of the battery 15 mounted on the battery mounting member 17 and over which the battery 15 is displaced toward the vehicle-widthwise outer side in the event of a collision of a vehicle 1, wherein the side restricting member 32 is joined to the battery mounting member 17.

With these configurations, regardless of a change in size of the battery 15 mounted on the vehicle body 2, the battery fixing structure can adequately restrict the battery 15 from jumping out in the event of a collision while suppressing a large-scale change to the vehicle body 2.

That is, in the present embodiment, the side restricting member 32 that restricts displacement of the battery 15 toward the vehicle-widthwise outer side is provided integrally with the bracket 30 configured to mount the front fender panel 50 on the vehicle body 2. Such a side restricting member 32 is mounted on the vehicle body 2 together with the bracket 30 after the step of assembling the vehicle body 2. Therefore, the side restricting member 32 can be disposed at a position adjacent to the vehicle-widthwise outer surface of the battery 15 only by changing the shape of the side restricting member 32 formed to be integrated with the bracket 30 according to the battery 15. This makes it possible to form a mounting space corresponding to the size of the battery 15 in the engine room 3 without changing the vehicle body frame of the vehicle body 2. In addition, the side restricting member 32 disposed at the position adjacent to the vehicle-widthwise outer surface of the battery 15 can restrict displacement of the battery 15 toward the vehicle-widthwise outer side in the event of a collision.

In this case, by integrally forming the side restricting member 32 with the bracket 30, the side restricting member 32 can be connected to the front fender panel 50 via the bracket 30. Therefore, only by joining the side restricting member 32 to the battery mounting member 17, it is possible to generate sufficient drag on the side restricting member 32 on which the collision load is concentrated by inertial force of the battery 15 in the event of a collision of the vehicle 1.

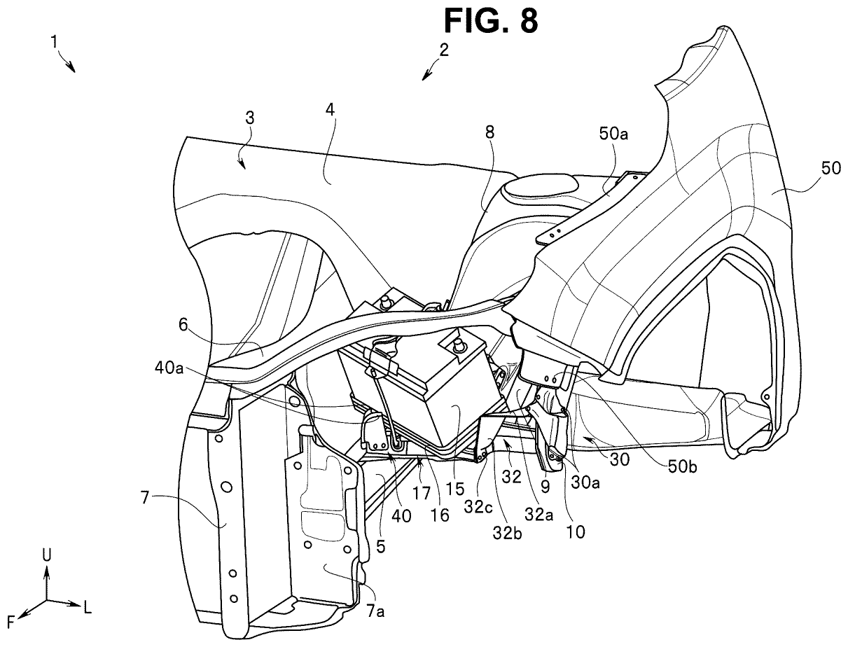

More specifically, the side restricting member 32 includes the vertical wall 32b opposite to the battery 15, and the top plate 32a extending toward the vehicle-widthwise outer side from the vertical wall 32b. The top plate 32a is connected to the front fender panel 50 via the bracket 30. With these configurations, the top plate 32a can generate sufficient drag on the vertical wall 32b on which the collision load is concentrated by inertial force of the battery 15 in the event of a collision of the vehicle 1. That is, as illustrated in FIG. 8, when the right front part of the vehicle 1 is involved in a small-overlap frontal collision, the side restricting member 32 can adequately restrict the displacement amount of the battery 15 moving toward the vehicle-widthwise outer side when a moment toward the vehicle-widthwise outer side acts on the battery 15.

Here, the position of the vertical wall 32b opposite to the vehicle-widthwise outer surface of the battery 15 can be easily changed, for example, by appropriately interposing the shelf 32d having any length corresponding to the size and the like of the battery 15 between the vertical wall 32b and the joining flange 32c.

For example, in the side restricting member 32 for the standard battery 15, the joining flange 32c can be formed substantially linearly at the distal end of the vertical wall 32b (refer to FIG. 5), and in the side restricting member 32 for the large battery 15b, the shelf 32d can be interposed (refer to FIG. 6 and FIG. 7) between the vertical wall 32b and the joining flange 32c. In this manner, by forming the shelf 32d between the vertical wall 32b and the joining flange 32c as necessary, the shape of the side restricting member 32 can be easily optimized depending on the size and the like of the battery 15. By selectively using such a side restricting member 32, the battery fixing structure of the present embodiment can restrict the displacement amount of the batteries 15 each having a different size and the like and moving toward the vehicle-widthwise outer side without changing the vehicle body frame and the like of the vehicle body 2.

In addition, in the present embodiment, the battery fixing structure including the side restricting member 32 includes the front restricting member 40 that restricts displacement of the battery 15 toward the vehicle-lengthwise front. Then, the front restricting member 40 is mounted on the corner of the battery mounting member 17 after the step of assembling the vehicle body 2. Therefore, the front restricting member 40 can be disposed at a position adjacent to the front surface of the battery 15 only by changing the shape of the front restricting member 40 according to the battery 15. This makes it possible to form a mounting space corresponding to the size of the battery 15 in the engine room 3 without changing the vehicle body frame of the vehicle body 2. In addition, the front restricting member 40 disposed at a position adjacent to the front surface of the battery 15 can restrict displacement of the battery 15 toward the vehicle-lengthwise front in the event of a collision.

Such a front restricting member 40 has sufficient drag against a collision load generated by inertial force of the battery 15 in the event of a collision of the vehicle 1.

Specifically, the front restricting member 40 is integrally formed by a pair of flat plates 40a. The pair of flat plates 40a has a substantially V-shape in plan view that opens at a substantially right angle toward the front surface of the battery 15. The pair of flat plates 40a can be firmly joined in a state in which the joint portions 40b formed continuously with each other abut on the respective front restricting member mounting surfaces 17h.

Therefore, the front restricting member 40 can generate sufficient drag against the collision load generated by inertial force of the battery 15 in the event of a collision of the vehicle 1 only by being joined to the corner of the battery mounting member 17. That is, as illustrated in FIG. 8, when the right front part of the vehicle 1 is involved in the small-overlap frontal collision, the front restricting member 40 can adequately restrict the displacement amount of the battery 15 moving toward the vehicle-lengthwise front.

Here, the position of the front restricting member 40 opposite to the front surface of the battery 15 can be easily changed, for example, by appropriately providing any notch corresponding to the size and the like of the battery 15 in a part of the pair of flat plates 40a.

For example, in the front restricting member 40 for the standard battery 15, the edges of the pair of flat plates 40a opposite to the battery 15 can be formed substantially linearly (refer to FIG. 5), and in the front restricting member 40 for the large battery 15b, an L-shaped notch can be provided in a part of the edges of the pair of flat plates 40a (refer to FIG. 6 and FIG. 7). In this manner, by providing a notch in a part of the edges of the pair of flat plates 40a as necessary, the shape of the front restricting member 40 can be easily optimized depending on the size and the like of the battery 15. The front restricting member 40 can be selectively used depending on the size and the like of the battery 15 together with the side restricting member 32. As a result, the battery fixing structure of the present embodiment can restrict the displacement amount of the batteries 15 each having a different size and the like and toward the vehicle-lengthwise front without changing the vehicle body frame and the like of the vehicle body 2.

Additionally, various fixing members (the battery stay 25, the front rod 26, and the rear rod 27) to be fixed to the battery mounting member 17 (the mounting surface 17b) are disposed on the front surface, the upper surface, and the rear surface of the battery 15. The height of the side restricting member 32 (the vertical wall 32b) relative to the battery 15 fixed by these various fixing members is set to be greater than the height of the front restricting member 40 (the pair of flat plates 40a) relative to the battery 15. As a result, the side restricting member 32 can increase restriction of the displacement amount of the battery 15 moving toward the vehicle-widthwise outer side with respect to a region on the vehicle-widthwise outer side of the battery 15 on which the fixing member is not disposed.

Therefore, in the battery fixing structure of the present embodiment, when the right front part of the vehicle 1 is involved in the small-overlap frontal collision, even in the large battery 15b on which a strong moment toward the vehicle-widthwise outer side acts at the initial stage of a collision, it is possible to adequately restrict the battery 15 from jumping out of the engine room.

The disclosure described in the above embodiments is not limited to these embodiments, and various modifications can be made in the implementation stage without departing from the gist of the disclosure. Furthermore, the above-described embodiments include disclosures at various stages, and various disclosures can be extracted by appropriately combining disclosed configuration elements.

In addition, even if some configuration elements are deleted from all the configuration elements described in the embodiments, a configuration from which the configuration elements are deleted can be extracted as the disclosure when the problem described can be solved and the effect described can be obtained.

According to a battery fixing structure of the disclosure, it is possible to adequately restrict a battery from jumping out in the event of a collision of a vehicle while suppressing a large-scale change to the vehicle body even when the size of the battery mounted on the vehicle body is changed.

1. A battery fixing structure comprising:
a battery mounting member configured to support a battery in an engine room of a vehicle;
a bracket configured to join a vehicle body panel of the vehicle to a vehicle body frame of the vehicle on an outer side of the battery mounting member in a vehicle width direction of the vehicle; and
a first restricting member provided integrally to the bracket and disposed at a first position which is opposite to an outer surface of the battery in the vehicle width direction, the battery being configured to move to the first position in a case where the battery is displaced toward an outer side of the vehicle width direction when the vehicle collides, wherein
the first restricting member is joined to the battery mounting member.

2. The battery fixing structure according to claim 1, further comprising a second restricting member joined to the battery mounting member, wherein
the second restricting member is disposed at a second position which is opposite to a front surface of the battery in a vehicle lengthwise direction of the vehicle, and
the battery is configured to move to the second position in a case where the battery is displaced toward a front side of the vehicle lengthwise direction of the vehicle when the vehicle collides.

3. The battery fixing structure according to claim 2, wherein
a height of the first restricting member relative to the battery mounted on the battery mounting member is greater than a height of the second restricting member relative to the battery.

4. The battery fixing structure according to claim 1, further comprising a fixing member configured to fix the battery to the battery mounting member, wherein
the fixing member includes:
a battery stay disposed in a lateral direction of an upper surface of the battery; and
rods each of which is fixed to corresponding one of both ends of the battery stay, and which have lower end parts locked so as to fix the battery to the battery mounting member.
